(19) United States
(12) Patent Application Publication
(10) Pub. No.: US 2018/0348683 A1
(43) Pub. Date: Dec. 6, 2018

(54) FIXING DEVICE

(71) Applicant: CANON KABUSHIKI KAISHA, Tokyo (JP)

(72) Inventors: Asuna Fukamachi, Kashiwa-shi (JP); Masanobu Tanaka, Kashiwa-shi (JP); Suguru Takeuchi, Funabashi-shi (JP); Oki Kitagawa, Nagareyama-shi (JP); Yasuharu Toratani, Abiko-shi (JP); Keita Ishiguro, Kawasaki-shi (JP)

(21) Appl. No.: 15/997,162

(22) Filed: Jun. 4, 2018

(30) Foreign Application Priority Data
Jun. 5, 2017 (JP) 2017-110673
May 2, 2018 (JP) 2018-088695

(51) Int. Cl. G03G 15/20

(52) U.S. Cl. CPC G03G 15/2089; G03G 15/2057; G03G 15/2078

(57) ABSTRACT

A fixing device includes first and second rotatable members forming a nip for fixing a toner image on a sheet; and a pressing mechanism for pressing one of said first and second rotatable members toward the other. A pressure P1 at a first position in an upstream side of a center in a recording material feeding direction, the pressure P1 is maximum in the nip, an average pressure PO from the first position to a downstream end of the nip in sheet feeding direction, a toner melt viscosity M1 at the first position, and a toner melt viscosity M2 at the second position, satisfy,

0.3 MPa≤P1≤0.65 MPa

0<P0≤0.25 MPa

1.0×10⁴ Pa·s≤M1<1.0×10⁵ Pa·s

0.5×10² Pa·s≤M2≤1.0×10³ Pa·s

### FIELD OF THE INVENTION AND RELATED ART

The present invention relates to a fixing device which is mountable in an image forming apparatus such as a copying machine, a printing machine, facsimileing machine, and the like.

A fixing device employed by an image forming apparatus provided with an image forming portion (electrophotographic image forming portion, for example) for fixing a toner image transferred onto a sheet of recording medium has a heating member as a fixing member, and a pressure applying member disposed in a manner to be pressed on the fixing member. As a sheet of recording medium, which is bearing an unfixed toner image, is conveyed through a nip formed by a combination of the fixing member and pressure applying means, the unfixed image on the sheet is fixed to the sheet.

More concretely, in the nip, the toner (toner particles), of which a toner image is formed, is heated to a temperature level higher than the glass transition temperature while remaining under the pressure applied by the pressure applying member. As the toner is heated to a temperature higher than the glass transition temperature, it becomes adhesive and elastic, while remaining under the pressure applied by the pressure applying member. That is, the toner image (toner particles) is subjected to a proper amount of pressure while remaining viscous after being softened and adhesive. Consequently, the toner particles are flattened and adhered to the sheet.

As toner particles are heated while being subjected to pressure, they change in shape and/or adhere to each other, forming therefore a thin layer of toner on the sheet of recording medium. Since the toner particles are under the pressure applied by the pressure applying member, the thin layer of toner is pressed upon the sheet. As the sheet of recording medium is conveyed out of the nip, the thin layer of toner cools down, and becomes fixed to the sheet. This process of fixing a toner image on a sheet of recording medium to the sheet by the application of heat and pressure to the sheet and the toner image thereon has sequential steps of melting, deforming, flattening, and adhering.

If a toner image having half-tone areas are excessively heated and/or pressed during a fixation process, in order to provide the surface of the toner image with gloss, the toner particles in the unfixed toner image excessively melt and spread, changing therefore in position and/or size. That is, as an unfixed toner image is excessively heated and/or pressed during the fixation process, it turns into a fixed toner image which is inferior in graininess.

There is disclosed In Japanese Laid-open Patent Application No. 2012-68401, an image forming apparatus structured to increase the difference in temperature between the top and bottom surfaces of a sheet of recoding medium, and also, to be less in the amount of pressure applied to a toner image (toner particles) in order to prevent melted (softened) toner particles from excessively spreading. Further, there is disclosed in Japanese Laid-open Patent Application No. 2012-118371, an image forming apparatus structured to coat a color toner image with transparent toner, which is lower in softening point than the toners of which the color toner image is formed, in order to prevent color toner particles from excessively spreading as it softens (melts).

However, the conventional technologies described above suffer from the issue that if a fixing device is structured to prevent toner particles from excessively spreading as they soften (melt), in order to improve the apparatus in terms of the graininess of an image, it is impossible to improve the apparatus in terms of glossiness of an image, without affecting the apparatus in the graininess of an image.

### SUMMARY OF THE INVENTION

Thus, the primary object of the present invention is to provide a fixing device which can prevent toner particles from excessively spreading as they soften (melt), in order to obtain an image which is excellent in terms of graininess, and also, is capable of outputting an image which is excellent in graininess, and yet, is desirable in glossiness.

According to an aspect of the present invention, there is provided a fixing device comprising first and second rotatable members cooperative with each other to form a nip for fixing a toner image on a recording material; and a pressing mechanism configured to press at least one of said first and second rotatable members toward the other; wherein a pressure P1 at a first position in an upstream side of a center of a recording material feeding direction, the pressure P1 is maximum in the nip, an average pressure PO from the first position to a second position which is a downstream end of the nip in recording material feeding direction, a toner melt viscosity M1 at the first position, and a toner melt viscosity M2 at the second position, satisfy,

0.3 MPa≤P1≤0.65 MPa

0<P0≤0.25 MPa

1.0×10⁴ Pa·s≤M1<1.0×10⁵ Pa·s

0.5×10² Pa·s≤M2≤1.0×10³ Pa·s

Further features of the present invention will become apparent from the following description of exemplary embodiments with reference to the attached drawings.

### BRIEF DESCRIPTION OF THE DRAWINGS

FIG. 1 is a sectional view of the fixing device in the first embodiment of the present invention.

FIG. 2 is a sectional view of the pressure pad (pressure applying member) in the first embodiment.

FIG. 3 is a block diagram of a part of the control system of the image forming apparatus (fixing device, in particular) in the first embodiment.

Parts (a), (b) and (c) of FIG. 4 are graphs of a toner viscosity, a toner temperature, and a pressure distribution in the fixation nip, in the first embodiment.

FIG. 5 is a table for showing the effectiveness of the first embodiment of the present invention, in comparison to those of comparative fixing devicees.

FIG. 6 is a sectional view of the fixing device in the second embodiment of the present invention.

FIG. 7 is a graph which shows the relationship between the surface pressure distribution in the fixation nip in the second embodiment.

FIG. 8 is a flowchart of the nip pressure adjustment operation in the second embodiment.

FIG. 9 is a sectional view of an image forming apparatus having a fixing device which is in accordance with the present invention.

### DESCRIPTION OF THE EMBODIMENTS

Hereinafter, embodiments of the present invention are described with reference to appended drawings.

### Embodiment 1

### (Image Forming Apparatus)

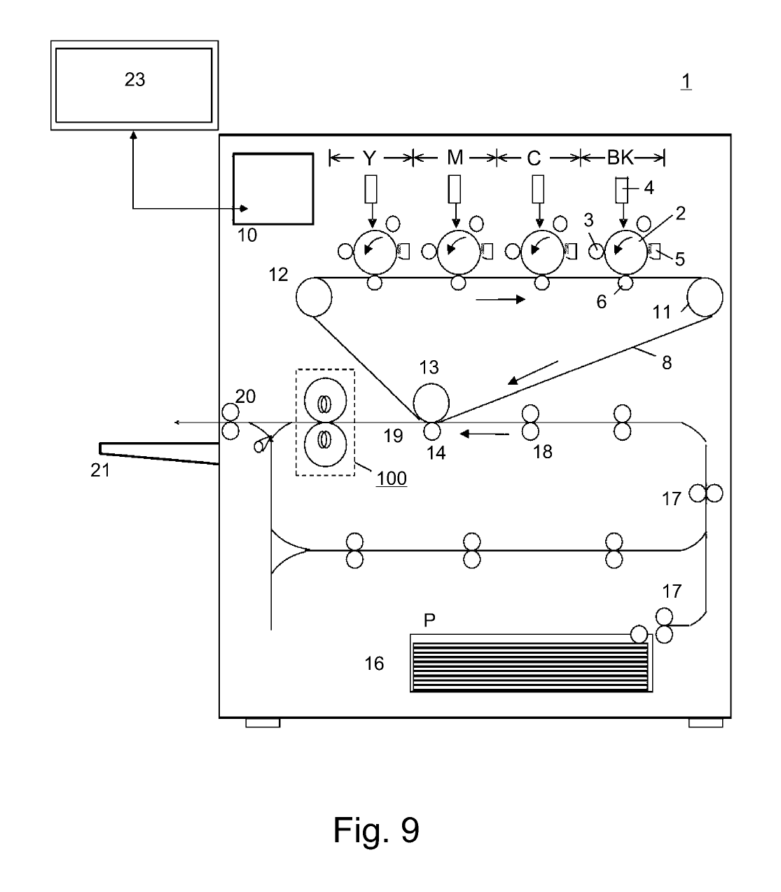

To begin with, referring to FIG. 9, the image forming apparatus having a fixing device 100 which is in accordance with the present invention is described about its overall structure. This image forming apparatus is a color laser beam printer, which uses an electrophotographic image formation system. Hereafter, this electrophotographic color printer is referred to simply as a “printer”.

The printer shown in FIG. 9 has four image forming portions which form Y (yellow), M (magenta), C (cyan) and Bk (black) toner images, one for one. A photosensitive drum 2 is charged by a charge roller 3. Then, a latent image is formed on the charged portion of the peripheral surface of the photosensitive drum 2 by a laser scanner 4. The latent image is developed into a toner image (image formed of toner) by a developing device 5. Then, the toner images on the peripheral surfaces of the photosensitive drums 2 are sequentially transferred onto an intermediary transfer belt 8, for example, which is an image bearing member.

Meanwhile, the sheets P of recording medium (paper, for example) in a sheet-feeding cassette are fed one by one into the main assembly of the image forming apparatus 1 while being separated from the rest in the cassette by the operation of a sheet-feeding mechanism. Then, each sheet P is sent to a pair of registration rollers 18 through a sheet conveyance passage 17. The pair of registration rollers 18 are kept stationary until the sheet P comes into contact with the nip between the pair of registration rollers 18. Thus, if the sheet P happens to be delivered askew to the nip, it is corrected in attitude (straightened) by the nip. Then, the sheet P is conveyed by the pair of registration rollers 18 to the area of contact between the intermediary transfer belt 8 and a secondary transfer roller 14, with such timing that the sheet P arrives at the nip at the same time as the toner image (images) on the intermediary transfer belt 8.

The monochromatic color toner images on the intermediary transfer belt 8 are transferred onto the sheet P by the secondary transfer roller 14, which is a transferring member. Thereafter, the sheet P and the toner images thereon are pressed, while being heated, by the fixing device 100. Consequently, the toner images become fixed to the sheet P. Then, the sheet P, to which the toner images have just been fixed, is discharged into a delivery tray 21 by a pair of discharged rollers 20.

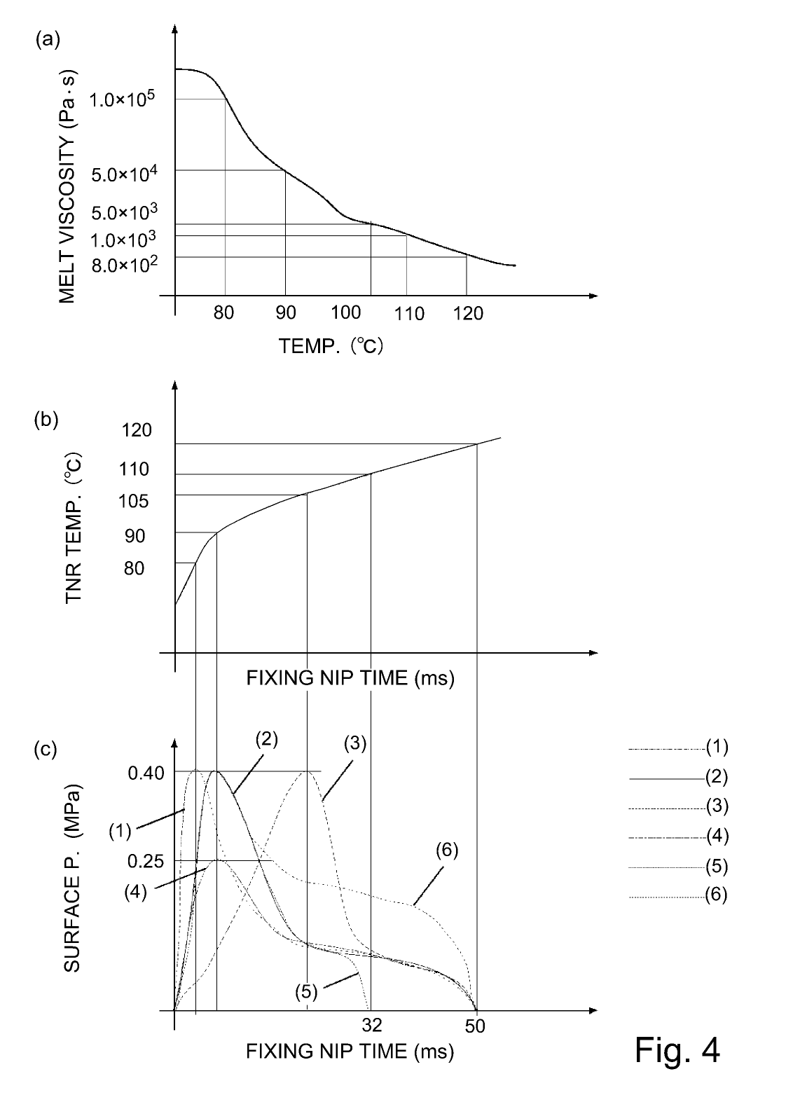

Next, referring to FIG. 3, this image forming apparatus has: a control portion, which typically is a CPU 10; a controller 37 which controls the fixing device and its peripheral devices; and a control panel 23 which functions as an interface between the image forming apparatus and a user. The CPU 10 manages the overall operation of the image forming apparatus by controlling the chain of commands among units while checking and controlling each section of the apparatus.

The image forming apparatus 1 is structured so that its control panel 23 is usable by a user to input basic settings (recording medium information such as basis weight and surface properties, print count of job, printing mode (one sided or two-sided mode, etc.) for a printing job. By the way, the information regarding a print job can be inputted into the image forming apparatus 1 from an external PC, or the like, beside the control panel 23. The controller 37 controls the motor for driving the fixing device 100, the separation-connection motor, etc.

### (Fixing Device)

Regarding the orientation of the fixing members of the fixing device in this embodiment which is to be described next, the “lengthwise direction” is such a direction that is perpendicular to the recording medium conveyance direction, and the thickness direction of recording medium.

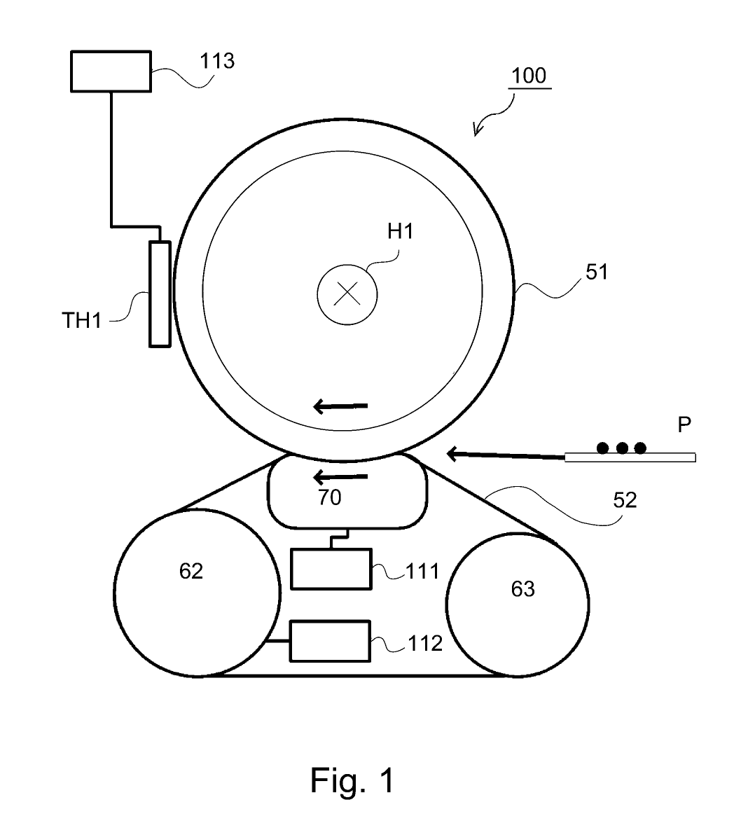

The fixing device 100 shown in FIG. 1 has the first and second rotational members. The first one is a fixation roller 51. The second one is provided with a pressure belt 52, which is an endless belt and is rotationally movable while being kept pressed upon the fixation roller 51. Its lengthwise direction coincides with the aforementioned “lengthwise direction”. The fixing device 100 is also provided with a combination of a pressure pad 70, and a pair of springs 111 (pressure applying means) disposed at the lengthwise ends of the pressure pad 70 to apply pressure to the pressure pad 70. As a sheet P of recording medium, which is bearing a toner image (image), is conveyed through the nip while remaining pinched between the fixation roller 51 and pressure belt 51, the toner image is fixed to the sheet P.

By the way, in FIG. 1, referential codes 112 and 113 stand for a driving mechanism and a temperature controlling system, respectively.

The fixation roller 51 is made up of a metallic core formed of Al, Fe, or the like, and an elastic layer formed of silicon rubber, fluorine rubber, or the like, in a manner to cover the peripheral surface of the metallic core. Further, the fixing device 100 is provided with a halogen heater H1, as a heat-generating member (heating means) which is disposed in the hollow of the metallic core in such an attitude that it extends in the lengthwise direction from one end of the metallic core to the other. Further, the fixing device 100 is provided with a thermistor TH1, which is disposed in contact with the fixation roller 51, or with no contact with the fixation roller 51. The halogen heater H1 is turned on or off by the CPU 10 (FIG. 3) to keep the surface temperature of the fixation roller 51 at a preset level, for example, 180° C.

The fixation roller 51 is rotationally driven by a driving force source (unshown), in the direction indicated by an arrow mark, at a preset peripheral velocity, for example, 400 mm/sec, with the pressure belt 52 being kept pressed against the fixation roller 51. The pressure belt 52 is made up of a substrative layer, and an elastic layer formed on the outward surface of the substrative layer. The substrative layer is formed of resinous substance such as polyimde, or a metallic substance such as nickel. The pressure belt 52 is suspended and kept tensioned by a combination of a driving roller 62 and a tension roller 63. It is rotationally driven by the driving force inputted into the driving roller 62 from a driving force source (unshown).

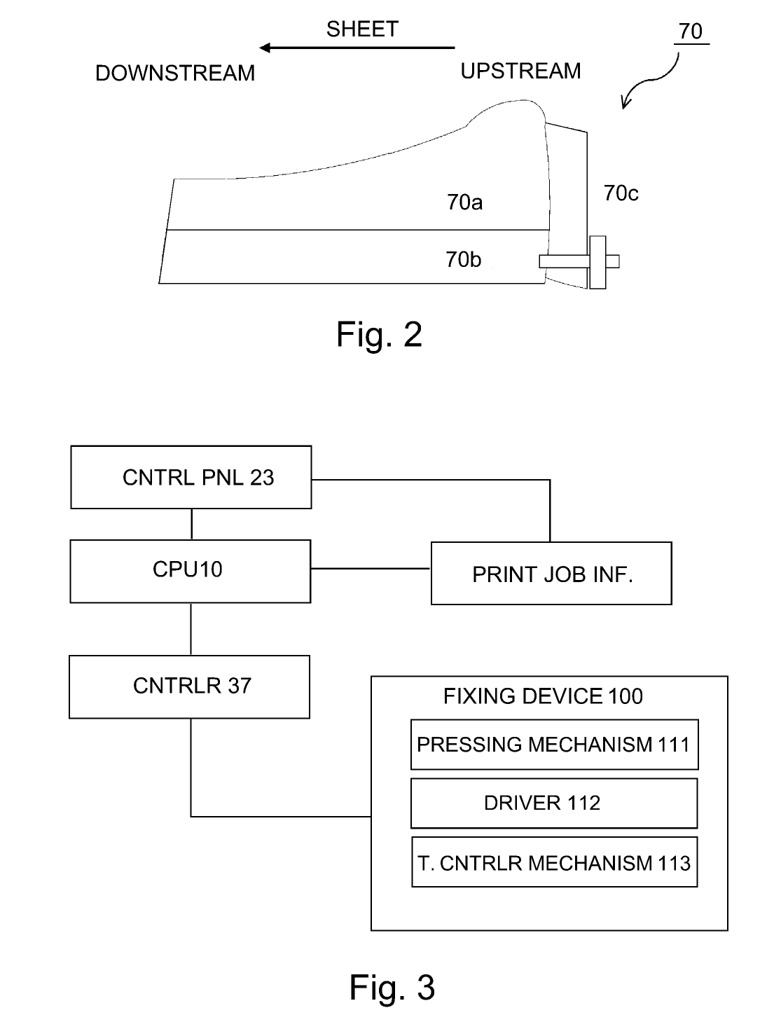

In this embodiment, the fixing device 100 is structured so that the nip pressure is higher on the entrance side of the nip (upstream side of center of nip in terms of recording medium conveyance direction), as will be described later. FIG. 2 is a schematic sectional view, at a plane perpendicular to the lengthwise direction of the fixing device 100, of the pressure pad 70, which is capable of providing a fixation nip with such a pressure distribution that is higher in pressure on the entrance side, in terms of the recording medium conveyance direction than the exit side. It shows an example of the shape of a pressure pad capable of providing the fixation nip with the above-described pressure distribution.

Referring to FIG. 2, the pressure pad 70 is shaped so that, in terms of the direction perpendicular to the recording medium conveyance direction, its elastic layer 70a is thicker on the upstream side than the downstream side. That is, the pressure pad 70 is such an elastic layer 70a that is thickest at the first position which is on the upstream side with reference to the center of the nip, and gradually reduces in thickness toward the downstream end.

When the nip pressure is P1 at the first position, which is on the upstream side of the center of the nip in terms of the recording medium conveyance direction, and at which the nip pressure is highest; the average nip pressure between the first position, and the second position which corresponds to the downstream end of the fixation nip, in terms of the recording medium conveyance direction, and is on the downstream side of the first position, is P0; the toner viscosity at the first position is M1; and the toner viscosity at the second position is M2, the following four conditions are satisfied.

0.3 MPa≤P1≤0.65 MPa

0<P0≤0.25 MPa

1.0×10⁴ Pa·s≤M1<1.0×10⁵ Pa·s

0.5×10² Pa·s≤M2≤1.0×10³ Pa·s

Preferably, the following four conditions are satisfied.

0.3 MPa≤P1≤0.5 MPa

0<P0≤0.25 MPa

5.0×10⁴ Pa·s≤M1≤1.0×10⁵ Pa·s

0.5×10² Pa·s≤M2≤1.0×10³ Pa·s

The pressure pad 70 has two layers, that is, a base layer 70b formed of stainless steel, and an elastic layer formed of silicon rubber and adhered to the base layer 70b. The fixing device 100 is also provided with a friction-reducing member (unshown) is disposed between the pressure pad 70 and pressure belt 52 to minimize the friction between the pressure pad 70 and pressure belt 52, which rub against each other as the fixation roller 51 is rotationally driven. This friction-reducing member is a piece of glass cloth coated with fluorinated resin (PTFE) to make the friction-reducing member slipperier.

Further, referring to FIG. 2, in this embodiment, the fixing device 100 is provided with a supporting member 70c attached to the upstream surface (nip entrance side) of the base layer 70b of pressure pad 70 to ensure that the elastic layer 70a holds its shape even when the elastic layer 70a comes under pressure.

The pressure pad 70 is nonrotational. It is disposed on the inward side of the loop (belt loop) which the pressure belt 52 forms, and keeps the pressure belt 52 pressed upon the peripheral surface of the fixation roller 51 across the area between the entrance (upstream) side of the nip to the exit (downstream) side of the nip. It is kept pressed toward the fixation roller 51 by the pressure application mechanisms disposed on the base side of the pressure pad 70, with the presence of the pressure belt 52 between itself and the fixation roller 51.

That is, a pair of the pressure application mechanisms 111 (which comprise springs (FIG. 1)) are disposed on the lengthwise ends of the base layer 70b of the pressure pad 70, one for one. Thus, the pressure pad 70 which is under the pressure application mechanisms 111 keeps the pressure belt 52 pressed upon the fixation roller 51. Further, the fixing device 100 is provided with an unshown cam driving mechanism. Thus, the amount by which pressure is applied to the pressure pad 70 can be adjusted by rotationally driving the cam with use of the cam driving mechanism to change the cam in angle (phase).

In this embodiment, cyan, magenta, yellow and black toners which contain wax, are used as the toners for forming unfixed toner images. The image data to be inputted into the image forming portions are the data (600 dpi; 0-255) regarding the primary colors C, M, Y and K, to which an original image to be copied, or nonoriginal image to be formed, are separated. Here, the amount of data per pixel is referred to as an image data amount. The maximum amount of data per primary color is 100%. The amount by which toner is used to form each pixel is calculated based on the image data amount, which is in a range of 0-100%.

A “toner amount” is the amount by which toner is used to form each of the pixels, of which an image is formed. The toner amount is expressed by a value in a range of 0-100% like the image data amount. The weight of the toner adhered to recording medium per 1 cm² to form an image is referred to as “toner load”. Thus, when an image is monochromatic, and 100% in toner amount, the image is maximum in toner load, and is highest in density. In this embodiment, the image forming apparatus is adjusted in toner load so that a halftone image is 0.5 mg/cm² in each primary color. Also in this embodiment, paper (gloss coat paper which is 128 g/m² in basis weight: product of Company A) was used as recording medium (sheet P of paper).

In the nip (fixation nip), toner is heated to a temperature level higher than the glass transition temperature while being kept under pressure. Thus, as the toner softens enough for its viscosity to reduce to a preset level, the toner particles spread and adhere to a sheet P of recording medium. If the toner particles excessively spread, it is possible that the toner image will be changed in position and/or size, and also, the resultant fixed image will be inferior in terms of graininess.

In this embodiment, therefore, in order to minimize the amount by which toner particles spread as they soften (melt), the fixing device 100 is structured so that a sheet P of recording medium is subjected to the largest amount of pressure (maximum surface pressure) when a given point of the sheet P in terms of the recording medium conveyance direction is in a position of the nip, which is very close to the upstream end of the nip, and in which the toner temperature will be 90° C., that is, as soon as the given point of the sheet P enters the nip, and then, the nip pressure gradually reduces toward the downstream end of the nip. That is, by applying relatively high pressure to the toner on a sheet of recording medium when the toner is relatively high in viscosity, it is possible to make the toner particles in the toner image to deform to such a degree that the area of contact between each toner particle to a sheet of recording medium becomes sufficient in size; the toner particles in the bottom portion of the toner layer do not excessively spread; and the toner particles in the top portion of the toner layer satisfactorily adhere to each other.

In terms of the conventional definition, “nip time” is a value obtained by dividing the nip width (dimension of nip in terms of recording medium conveyance direction) by fixation speed. In this specification, however, it sometimes means the length of time it takes for a given point of a sheet of recording medium in terms of the recording medium conveyance direction to reach the downstream end of the nip after the point is subjected to the maximum amount of surface pressure in the nip. In this embodiment, the fixing device 100 is structured so that after the application of the largest amount of surface pressure to the toner image, the amount by which pressure is applied to the toner image (toner particles) is kept minimum (which includes zero).

That is, the length of time it takes for a given point of a sheet P of recording medium, in terms of the recording medium conveyance direction, to move from the first position, in which the point is subjected to the largest amount of nip pressure, to the downstream end (second position) of the nip in terms of the recording medium conveyance direction, is longer than the length of time it takes for the point to reach the first position, or the position in which the point is subjected to the largest amount of nip pressure, after it enters the nip. That is, the length of time it takes for the leading edge of the sheet P in terms of the recording medium conveyance direction to reach the downstream end (second position) of the nip after it is subjected to the highest pressure in the first position is longer than the length of time it takes for the leading edge of the sheet P in terms of the recording medium conveyance direction, to be subjected to the largest pressure in the nip after entering the nip. Similarly, the length of time it takes for the leading edge of the image formation area of the sheet P, in terms of the recording medium conveyance direction, to move from the first position where the point is subjected to the largest amount of nip pressure, to the downstream end of the nip, is longer than the length of time it takes for the point to reach the first position after it enters the fixation nip. Therefore, it is possible to melt the toner particles in the top portion of the toner layer on the sheet P by the amount of heat given to the toner image during the nip time, in order to make the toner layer flat across its top surface so that the toner image will be glossy after the fixation.

Part (a) of FIG. 4 shows the relationship among a location in the nip, in terms of the recording medium conveyance direction, temperature (toner temperature) at the location, and the toner viscosity at the location. Part (b) of FIG. 4 shows the relationship between a location in the nip, in terms of the recording medium conveyance direction, and the temperature (toner temperature) at the location. The solid line in part (c) of FIG. 4 represents the relationship among a location in the nip, in terms of the recording medium conveyance direction, the nip pressure (surface pressure), and nip time.

The toner viscosity was measured with the use of a Flow Tester CFT-500D (product of Shimazu Co., Ltd.), under the following conditions (a)-(e), following the operational manual for the tester. In this embodiment, the binder of the color toners was polyester. The method used for manufacturing the color toners is pulverization. By the way, the toner ingredients and the method for manufacturing the color toner do not need to be limited to the abovementioned ones. For example, the method for manufacturing the toner may be such polymerization as suspension polymerization and interfacial polymerization.

### [Conditions]

(a) Sample: 1.0 g of toner (measured with balance) is placed in a compression molding device, which was 1 cm in diameter, and was compressed for one minute with the application of 20 kN of load to obtain samples.

(b) Die diameter: 1.0 mm

(c) Die length: 1.0 mm

(d) Cylinder pressure: 9.807×10⁵ (Pa)

(e) Measurement mode: warm-up speed: 4.0° C./min

Toner viscosity (Pa·s) was measured with the use of the above-described method in a temperature range of 50° C.-200° C.

As for toner temperature, a sheet of paper, which was equipped with a thermocouple of type K, was conveyed through the fixation nip while monitoring the temperature, to obtain the toner temperature profile relative to the elapsed length of time while the sheet P is conveyed through the fixation nip.

As for the pressure distribution (surface pressure distribution), it was measured with the use of a tactile sensor (Sealer: product of Nitta Co., Ltd.), with a sheet P of recording medium held in the nip.

In this embodiment, the fixing device 100 is structured so that the nip pressure become the highest (4.0 MPa) when the nip temperature is 90° C., at which toner viscosity becomes 50×10⁴ Pa·s, as is indicated by the solid line (Condition 2) in part (c) of FIG. 4. More specifically, the elastic layer 70a of the pressure pad 70 shown in FIG. 2 was shaped to satisfy Condition 2. During this process, the temperature of the fixation roller 51 was kept at 185° C. Further, the nip width (nip dimension in terms of recording medium conveyance direction) was 20 mm, and the fixation speed was set to 400 mm/s. Thus, the nip time was 50 ms.

Further, at the nip exit (downstream end of nip), the toner temperature was 120° C. (part (b) of FIG. 4), and the toner viscosity was 800 (8.0×10²) Pa·s (part (a) of FIG. 4). Further, the fixing device 100 was structured so that the nip pressure is largest (0.4 MPa in surface pressure) in the immediate adjacencies of the nip entrance, and reduces at a relatively high rate toward the nip exit, and also, so that the average surface pressure between the point, in the immediately adjacencies of the nip entrance, at which the toner image (toner particles) is subjected to the highest nip pressure, and the downstream end of the nip in terms of the recording medium conveyance direction was 0.2 MPa.

If the toner viscosity is excessively high when the toner is subjected to the largest surface pressure, or the largest surface pressure is too low, toner fails to properly deform, and therefore, the top surface of the toner layer fails to become flat enough to provide the toner image with satisfactory gloss. Further, if the downstream half of the fixation nip is insufficient in the amount by which it can provide a sheet P of recording medium with heat, the top surface of the toner layer does not become flat, and therefore, fails to provided the toner image with insufficient gloss, even if the nip is proper (highest) in surface pressure. Further, if the toner is insufficient in viscosity when it is subjected to the largest amount of surface pressure, or if an excessive amount of pressure is applied to the toner when the toner is low in viscosity, the toner particles excessively spread, reducing thereby the toner image in graininess (clearness).

Thus, the fixing device 100 was changed in the location in the nip, in terms of the recording medium conveyance direction, at which the surface pressure is largest, in order to change the fixing device 100 in the viscosity which toner particles will have when they are subjected to 4.0 MPa of surface pressure, that is, the largest surface pressure. Then, the fixed images were evaluated in gloss and graininess. The fixed images were also evaluated in gloss and graininess under the condition in which the fixing device was reduced in the amount of the largest surface pressure; it was reduced in the length of nip time, that is, the length of time which elapses between the point in time at which the largest surface pressure is applied, and the downstream end of the nip; and the fixing device 100 was increased in the average surface pressure between the point at which the fixing device 100 was largest in surface pressure, and the sheet exit of the fixing device 100. The experiments which involved the changes in the pattern of the pressure distribution in the nip were carried out by changing the pressure pad 70 in shape or changing the fixing device 100 in the amount by which pressure was applied.

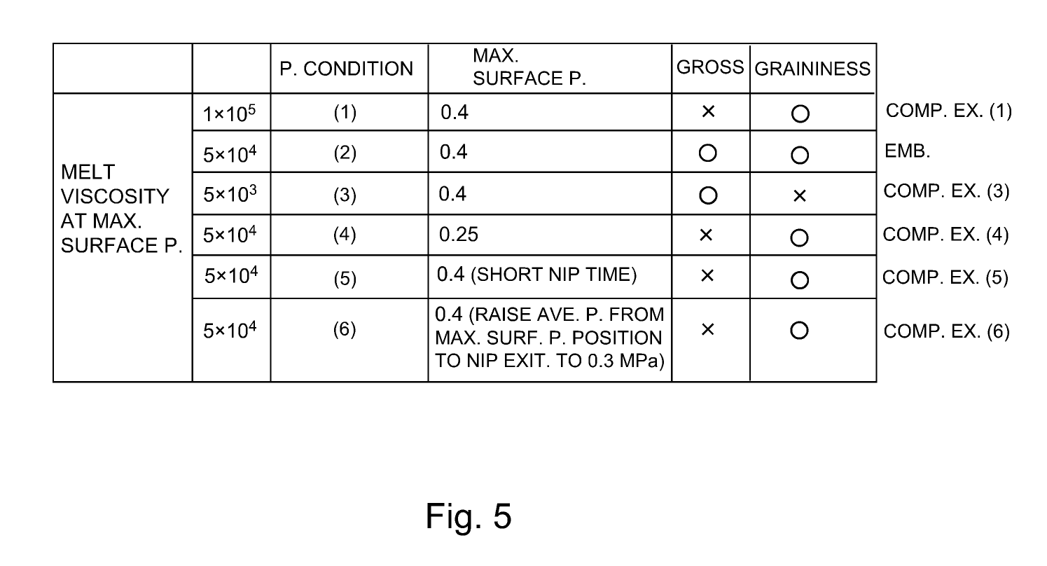

The degree of glossiness (which hereafter will be referred to simply as “gloss”) of the fixed images was measured with the use of a Handy Gloss Meter (PG-1M: product of Nippon Denshoku Industries Co., Ltd.) (in accordance with specular glossiness measuring method JIS Z8741). When a fixed toner image was no less than a preset value in 60° glossiness value, the toner image was judged excellent in glossiness (o in glossiness column in FIG. 5 indicates that toner image was satisfactory in gloss, whereas x indicates that toner image was unsatisfactory in gloss).

Graininess was measured with the use of Wiener spectral, which is a power spectral of density fluctuation. The values obtained by integrating the Wiener spectral of an image and Visual transfer function (VTF) after cascading was used as graininess index (GS). The greater a toner image is in GS value, the more inferior it is in graininess (Referential documents: R. P. Dooley, R. Show: Noise Perception in Electrophotography” J. Appl. Photogr. Eng., 5(4)). In this embodiment, when a toner image is no greater in GS than a preset value, it is judged excellent (satisfactory) in graininess ((o in glossiness column in FIG. 5 indicates that toner image was satisfactory in glossiness, whereas x indicates that toner image was unsatisfactory in glossiness).

Regarding Conditions (1)-(6) shown in FIG. 5, the surface pressure distribution is shown in part (c) of FIG. 4, and the results of the evaluation of toner images in glossiness are shown in FIG. 5. In part (c) of FIG. 4, a solid line (2) corresponds to this embodiment, whereas a solid line (1) corresponds to a comparative fixing device (1), and solid lines (3)-(6) correspond to comparative fixing devicees (3)-(6).

In Condition (1), in which surface pressure is largest, and toner particles were 1.0×10⁵ Pa·s in viscosity (toner temperature was 80° C.), toner particles did not spread very wide, and the difference among toner particles in terms of the extent of spreading was small. Thus, toner images were satisfactory in graininess. However, toner particles failed to fully melt, and therefore, toner images were not smooth across their top surface, being therefore unsatisfactory in gloss. In Condition (3), in which the surface pressure is the largest, and toner is 1.0×10³ Pa·s in viscosity (toner temperature was 105° C.), toner particles spread excessively wide, and therefore, toner images were unsatisfactory in graininess.

In Condition (4) in which the largest surface pressure was 0.25 MPa, toner particles did not spread wide, and the difference among toner particles in the extent of spreading was small. Thus, the toner images were satisfactory in graininess. However, the toner particles failed to completely melt. Therefore, the toner images were not as flat across their top surface as they should be. Therefore, they were unsatisfactory in gloss. In Condition (4), even when the largest surface pressure was increased to 0.65 MPa, toner images were satisfactory in graininess. but as it was raised to 0.70 MPa, toner particles excessively spread, and therefore, toner images were unsatisfactory in graininess. Further, in Condition (5), when the nip time (length of time it takes for given point of sheet of recording medium to move from where surface pressure is largest in nip, and downstream end of nip) was 15 ms, which is relatively short, toner temperature was 110° C. (part (b) of FIG. 4) (which is substantially lower than 120° C.) at the nip exit (downstream end of nip). Therefore, the amount by which heat was applied to the toner image (toner particles) was insufficient. Therefore, the top surface of the toner image was inferior in terms of flatness. Therefore, the toner images were unsatisfactory in gloss. In this case, the toner (toner image) was 1.5×10³ Pa·s in viscosity at the nip exit (part (a) of FIG. 4). In Condition (5) or (2), as the nip time was extended to 100 ms, toner images improved in graininess and gloss. However, as the nip time was extend to 120 ms, toner particles excessively spread, and therefore, toner images became unsatisfactory in graininess. In a case where the nip time was 100 ms, toner temperature and toner viscosity were 140° C. and 0.5×10² MPa, respectively, at the nip exit.

Further, in Condition (6), as the average surface pressure of the downstream half of the fixation nip of the fixing device 100 was increased from 0.25 MPa to 0.3 MPa, toner particles excessively spread, and therefore, toner images became unsatisfactory in graininess.

As will be evident from the foregoing, the fixing device 100 is desired to be structured so that when the surface pressure is largest, toner viscosity is no less than 1.0×10⁴ Pa·s, preferably, 5.0×10⁴ Pa·s. Regarding the average surface pressure between the point at which the largest surface pressure is applied, and the nip exit (downstream end of nip), when it is higher than 0 MPa, (therefore, nip can hold sheet P of recording medium), but no higher than 0.25 MPa, the fixing device 100 is satisfactory in terms of the graininess of image. Further, when the average surface pressure is in the above-described range; the largest surface pressure is no less than 0.3 MPa and no more than 0.65 MPa (preferably, 0.5 Mpa); and, and the nip time (after application of largest surface pressure) is longer than 15 ms (preferably, no less than 20 ms) and no more than 100 ms, toner images become satisfactory in both gloss and graininess. The changes which occur to the glossiness of a toner image are attributable to toner viscosity. Toner viscosity at the nip exit (downstream end of nip) is desired to be no less than 0.5×10² Pa·s, and no more than 1.5×10³ Pa·s (preferably, 1.0×10³ Pa·s).

By setting the conditions described above, it is possible to prevent toner particles from excessively spreading as they melt (soften). Therefore, it is possible to obtain images, which are satisfactory not only in glossiness, but also, graininess.

As described above, according to this embodiment, the fixing device 100 is structured so that the fixation pressure is largest in the entrance portion of the fixation nip, and substantially reduces toward the exit portion of the nip. Thus, the amount by which fixation pressure is applied is largest when toner is relatively high in viscosity, and gradually reduces toward the nip exit. Therefore, it is possible to minimize the amount by which toner particles excessively spread as they melt (soften). Further, a sufficient amount of nip time is secured to allow toner particles to sufficiently reduce in viscosity after the application of the largest amount of fixation pressure to the toner particles. Therefore, the toner particles in the top portion of the toner images (toner layer) are flattened as they are melted (softened) by the heat applied to the sheet P and the toner image thereon. Therefore, it is possible to obtained a fixed image which is satisfactorily high in gloss.

### Embodiment 2

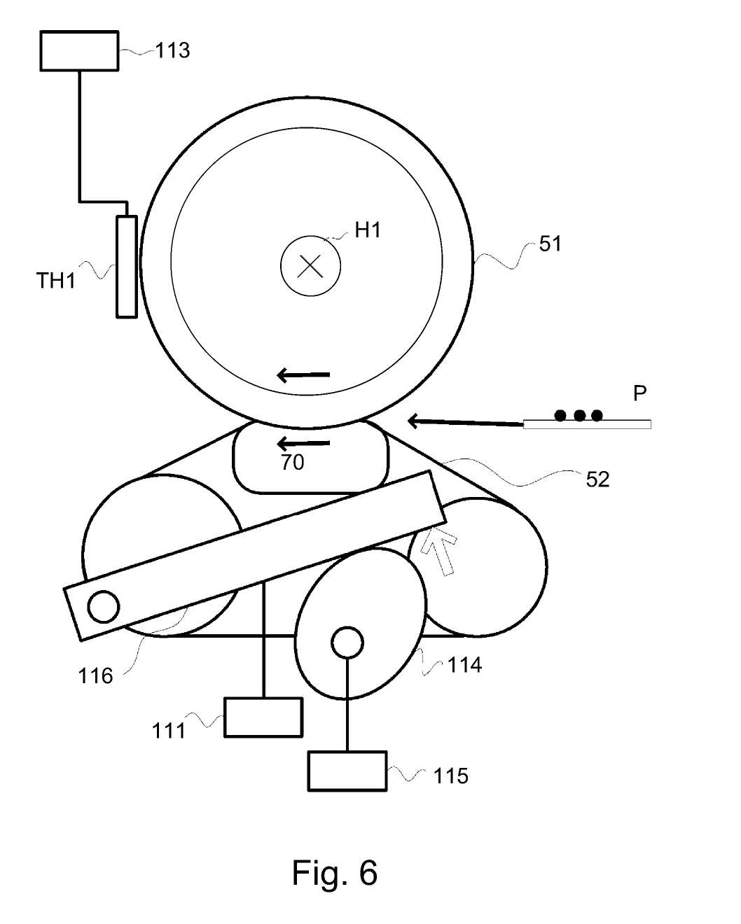

FIG. 6 is a sectional view of the fixing device in the second embodiment of the present invention. The characteristic feature of the fixing device in this embodiment is that the fixing device can be adjusted in the amount by which pressure is applied to the pressure pad 70, such as the one in the first embodiment, by the pressure application mechanisms 111, according to the thickness of a sheet of recording medium. The structural components of the apparatus in this embodiment, which are the same in structure as the counterparts in the first embodiment are not described.

In this embodiment, in order to ensure that even in a case where a sheet P of recording medium used for a given image forming operation is thicker than an ordinary sheet of recording paper, an image which is no lower in graininess than an image formed on a sheet of ordinary paper, and as high in gloss as an image formed on a sheet of ordinary paper can be obtained, the fixing device 100 is structured so that its pressure applying means comprising a pressure pad and a pressure application mechanisms can be adjusted in the amount by which it can apply pressure to the pressure pad 70. Generally speaking, the greater is a sheet of recording medium in basis weight, the greater it is in thermal capacity. Therefore, when a sheet of recording medium, which is thicker than a sheet of ordinary paper, is used as recording medium, a toner image is likely to be supplied with an insufficient amount of heat. Therefore, the toner image (toners particles) on the sheet of recording medium is likely to fail to sufficiently melt (soften). One of the solutions to this problem is to raise the target temperature for the fixing device to increase toner temperature. However, as a sheet of recording medium is increased in thickness, the surface pressure to which a toner image (toner particles) on the sheet is subjected increases, causing therefore the toner particles to excessively spread. Thus, the image forming apparatus sometimes outputs images which are unsatisfactory in graininess.

Referring to FIG. 6, the fixing device 100 is provided with a pair of pressure application mechanisms 111 (which comprises springs), which are disposed at the lengthwise ends of the base layer 70b of the pressure pad 70, one for one. The pressure pad 70 is pressed against the fixation roller 51, with the presence of the pressure belt 52 between itself and fixation roller 51, by a pair of pressure application links 116, which are under the pressure generated by the pair of pressure application mechanisms 111, one for one. Thus, the pressure pad 70 presses the pressure belt 52 upon the fixation roller 51. As a pair of cams 114 are rotationally driven by a pair of cam driving mechanisms 115, the cams 114 change in angle (attitude), adjusting therefore the amount by which pressure is applied to the fixation nip by the pressure applying means which includes the pressure pad 70, by way of the pair of pressure application mechanisms.

In this embodiment, paper (gloss coat paper which is 350 g/m² in basis weight: product of Company B) was used as recording medium (sheet P of paper). The pressure distribution was measured with the use of a tactile sensor (product of Nitta Co., Ltd., Sealer), while a sheet P of recording medium is in the nip.

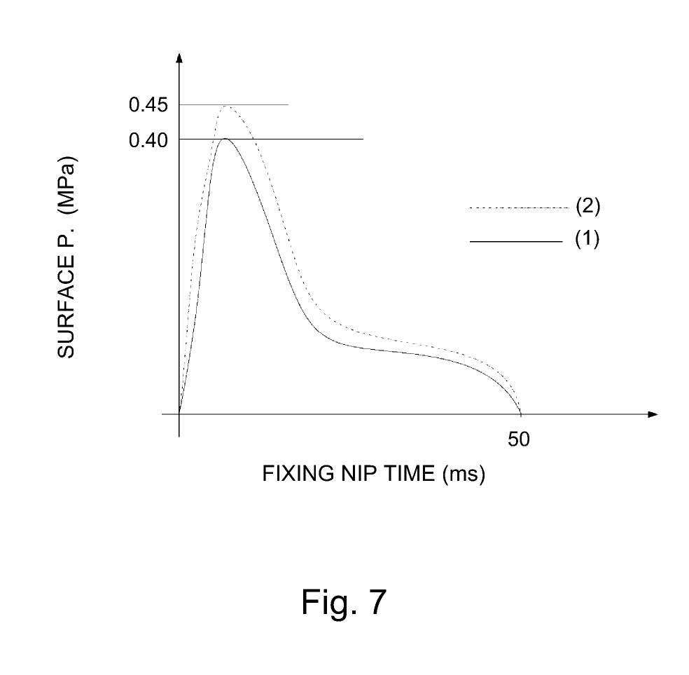

The broken line (2) in FIG. 7 which represents Condition (2) shows the relationship between the surface pressure at a given point in the nip, in terms of the recording medium conveyance direction, and the location of the given point in the nip. The solid line (1) in FIG. 7 which represents Condition (1) shows the relationship between the surface pressure and fixation nip time in the first embodiment. Referring to FIG. 7, when a sheet of paper which is thicker than a sheet of ordinary paper is used as recording medium, the amount of pressure to which a toner image is subjected (toner particles are subjected) is greater as indicated by the broken line (2). Thus, it is possible that the toner particles will excessively spread (wider than when ordinary sheet of paper is used as recording medium).

It is assumed here that the greater a sheet of recording medium is in basis weight, the thicker is the sheet. In this embodiment, therefore, the fixing device 100 was structured so that if the basis weight of recording medium inputted through the control panel of the image forming apparatus is greater than a preset amount, the amount by which pressure is applied by the above-described pressure applying means is reduced to apply a proper amount of pressure to the toner image (toner particles).

By the way, the fixation temperature was set to 200° C. so that the nip temperature at the nip exit (toner temperature at nip exit) became 120° C. As the aforementioned sheet of recording paper, which was bearing a toner image, was conveyed through the nip, the toner temperature changed in such a manner that is almost no different from the manner in which the toner temperature changed when a sheet of recording paper (gloss coat paper which is 128 g/cm² in basis weight: product of Company A) was conveyed, with the target temperature set to 180° C. That is, it was confirmed that there was virtually no change in the relationship between the nip time and the toner viscosity.

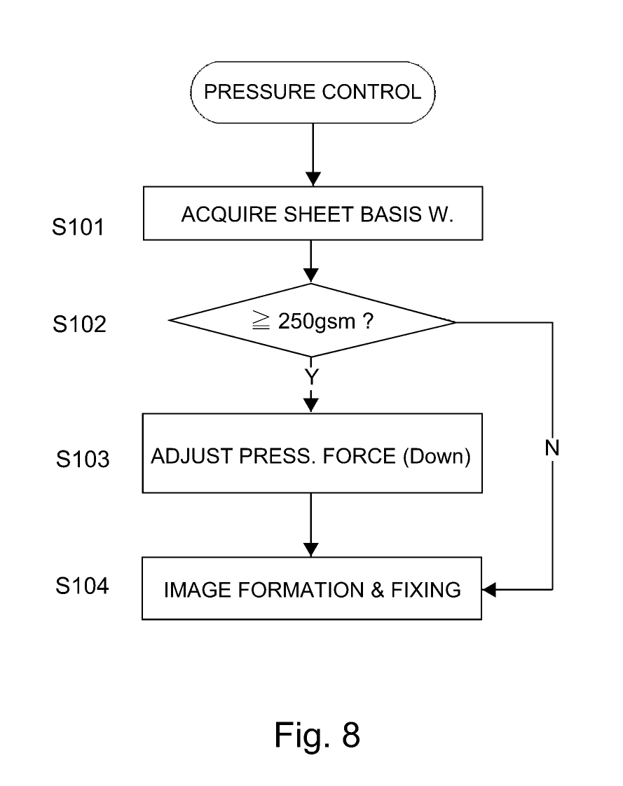

FIG. 8 is a flowchart of the operational sequence for adjusting the nip pressure according to the basis weight of a sheet of recording medium. In S101, the information regarding the basis weight of a sheet of recording medium is inputted through the control panel 23 (FIG. 3). In S102, the CPU 10 (FIG. 3) determines whether the basis weight obtained based on the basis weight information inputted in S101 is no less than 250 g/m² to decide whether the nip pressure is to be downwardly adjusted. If it determines that the basis weight is no less than 128 g/m², and the nip pressure is to be reduced, it proceeds to S103. If it determines that the basis weight is no more than 250 g/m² and the fixing device does not need to be adjusted in nip pressure, it proceeds to S104.

In S103, the CPU 10 activates the pressure application mechanisms 111 to downwardly adjust the amount of pressure to be applied by the pressure applying means which includes the pressure pad 70. In S104, the CPU 10 carries out an image forming operation and a fixing operation.

Also in this embodiment, the fixing device 100 was structured so that the nip pressure is largest in the upstream end portion of the nip, in terms of the recording medium conveyance direction, in which the toner particles are higher in viscosity than in the rest of the nip, and substantially reduces toward the downstream end, as in the first embodiment. Therefore, it is possible to minimize the amount by which the toner particles excessively spread as they melt (soften). Further, the fixing device was structured so that there is a sufficient amount of nip time for toner particles to reduce in viscosity after they are subjected to the largest amount of surface pressure. Therefore, it is possible to melt (soften) the top portion of the toner layer by the heat given to the toner particles during the nip time to flatten the top surface of the toner layer. Therefore, it is possible to obtain fixed images which are high in gloss.

Further, in this embodiment, the amount by which pressure is applied to a sheet of recording medium is adjusted according to the type (basis weight) of a sheet of recording medium. Therefore, it is possible to prevent the problem that the amount of pressure to which the toner particles on a sheet of recording medium are subjected is affected by the thickness of the sheet. Therefore, it is possible to regulate the amount by which toner particles spread as they melt (soften). Therefore, it is possible to obtain images which are higher in gloss, and yet, are excellent in terms of graininess.

### [Modifications]

In the forgoing, the present invention was described with reference to a couple of preferred embodiments of the present invention. However, these embodiments are not intended to limit the present invention in scope. That is, the present invention is also applicable to various fixing devicees which are different from those in the preceding embodiments, within the gist of its scope.

### Modification 1

In the embodiments described above, the pressure pad was shaped so that it is thickest at the first position, or the upstream end portion of the pad in terms of the recording medium conveyance direction, and gradually reduces in thickness toward the downstream end. These embodiments, however, are not intended to limit the present invention in terms of the shape of the pressure pad. For example, the present invention is also compatible with a pressure pad which is thickest across its upstream end portion, and reduces in thickness in steps toward the downstream end. Further, it is also compatible with a pressure pad shaped so that it is thickest at the first position and gradually reduces in thickness so that the amount of pressure it generates at its downstream end is zero.

Also in the embodiments described above, the fixing device was structured so that its endless belt was pressed upon its fixation roller. These embodiments, however, are not intended to limit the present invention in scope in terms of fixation apparatus structure. For example, the present invention is also applicable to a fixing device structured so that its endless belt is pressed by its pressure roller. That is, the present invention is applicable to any fixing device, as long as the apparatus employs a combination of an endless belt and a rotational member, and is structured so that the endless belt and rotational member are made to press upon each other. Further, the present invention is also applicable to a fixing device which employs a pair of endless belt, and is structured so that one of the endless belt presses upon the other.

### Modification 3

In the embodiments described above, the halogen heater, as a heat generating member, was disposed in the hollow of the fixation roller as a rotational member. These embodiments, however, are not intended to limit the present invention in scope in terms of the configuration of a fixing device. That is, the present invention is also applicable to a fixing device which employs an endless belt and a heater, as a heat generating member, for heating the endless belt, and is structured so that the heater is disposed in contact with the inward surface of the endless belt to heat the belt. Further, the present invention is also applicable to a fixing device which employs an endless belt having a heat generating layer which is made to generate heat by an excitation coil, or electric power supplied thereto (structured so that endless belt doubles as heat generating member for heating nip).

### Modification 4

In the embodiments described above, the recording medium was recording paper. These embodiments, however, are not intended to limit the present invention in terms of recording medium choice. Generally speaking, recording medium is medium on which a toner image can be formed by an image forming apparatus, and is in the form of a piece of sheet. It includes, a sheet of ordinary paper, cardstock, thin paper, etc., which is in a specific or nonspecific form. It includes also an envelop, a postcard, and a seal. Further, it includes a sheet of resinous substance, a sheet of OHP film, and a sheet of glossy paper. By the way, in the embodiments described above, how a sheet P of recording medium was manipulated was described with the use of such a term as “sheet-feeding”. However, these embodiments are not intended to limit the present invention in scope in terms of the recording medium choice; the application of the present invention is not limited to image forming apparatuses which are compatible with only sheets of paper.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2017-110673 filed on Jun. 5, 2017 and 2018-088695 filed on May 2, 2018, which are hereby incorporated by reference herein in their entirety.

What is claimed is:

1. A fixing device comprising:
first and second rotatable members cooperative with each other to form a nip for fixing a toner image on a recording material; and
a pressing mechanism configured to press at least one of said first and second rotatable members toward the other;
wherein a pressure P1 at a first position in an upstream side of a center of a recording material feeding direction, the pressure P1 is maximum in the nip,
an average pressure PO from the first position to a second position which is a downstream end of the nip in a recording material feeding direction,
a toner melt viscosity M1 at the first position, and
a toner melt viscosity M2 at the second position,
satisfy,
0.3 MPa≤P1≤0.65 MPa
0<P0≤0.25 MPa
1.0×10⁴ Pa·s≤M1<1.0×10⁵ Pa·s
0.5×10² Pa·s≤M2≤1.0×10³ Pa·s

2. A fixing device according to claim 1, wherein the following is satisfied,
0.3 MPa≤P1≤0.5 MPa
5.0×10⁴ Pa·s≤M1<1.0×10⁵ Pa·s.

3. A fixing device according to claim 1, wherein said first rotatable member includes a pressing pad having an elastic layer which is thickest at the first position in the nip portion and is thinner than a thickness at the first position in the downstream side of the first position.

4. A fixing device according to claim 3, wherein said pressing mechanism presses said pressing pad toward said second rotatable member.

5. A fixing device according to claim 1, wherein a time period from a leading edge of the recording material receiving a highest pressing force at the first position to reaching a downstream end of the nip portion is longer than a time period from the leading edge receiving enters the nip to the recoding material receiving the highest pressing force at the first position,

6. A fixing device according to claim 1, further comprising a heating portion configured to heat the nip.
